(19) United States
(12) Patent Application Publication
(10) Pub. No.: US 2012/0072957 A1
(43) Pub. Date: Mar. 22, 2012

(54) Providing Dynamic Content with an Electronic Video

(75) Inventors: Sai Suman Cherukuwada, Adliswil (CH); Steven G. Dropsho, Zurich (CH); Itamar Gilad, Zurich (CH); Christian I. Falk, Zurich (CH)

(73) Assignee: GOOGLE INC., Mountain View, CA (US)

(21) Appl. No.: 12/885,950

(22) Filed: Sep. 20, 2010

(51) Int. Cl. H04N 7/173

(52) U.S. Cl. 725/93

(57) ABSTRACT

In one implementation, a computer-implemented method includes receiving a request from a client computing device for an electronic video, and dynamically identifying content to display while the video is played based on one or more content parameters associated with the video that indicate, at least, a type of dynamic content to be identified after the request is received. The method can further include providing the identified dynamic content to the client computing device in a form so that the dynamic content will be displayed on the client computing device in accordance with one or more display parameters that indicate, at least, a time during playback of the video or a location in relation to the video at which the dynamic content is displayed.

### TECHNICAL FIELD

This document generally describes techniques, methods, systems, and computer program products for providing dynamic content with an electronic video.

### BACKGROUND

Many websites (e.g., FACEBOOK, YOUTUBE, etc.) permit users to upload electronic videos (e.g., FLASH videos, MPEG-2 encoded videos, QUICKTIME videos, etc.) to their computer server systems for distribution (e.g., streamed video playback, video file download, etc.) to other users over a network (e.g., the Internet). Some of these websites have allowed users to add static annotations (e.g., text, hyperlinks) to their videos. A video annotation is extra-video content that augments the content of the video. Annotations have been presented as text boxes overlaying portions of videos at user specified times and locations during video playback.

For example, assume that Alice is a user who uploads a one-minute video showing attractions in Hawaii, such as a beachfront resort at the start of the video and a surfing class at the 30 second mark. Alice can add video annotations throughout the video to describe these attractions. For instance, Alice can add a first video annotation with the name and a link to the webpage of the beachfront resort, a second video annotation with rates for the surfing class, and a third video annotation with a link to a travel website that offers airfare to Hawaii. Alice can designate that the first video annotation is displayed at the start of the video at specific location on the video (e.g., a location that will not obscure important content in the video) and that it lasts until the 30-second mark of the video (the start of the surfing class portion of the video). Alice can designate the second video annotation to be displayed at the 30-second mark of the video in another location on the video and to last until the end of the video. Alice can further designate the third video annotation to be displayed from the 45-second mark until the end of the video in a location different than the location of the second annotation. When another user, Bob, views Alice's video (e.g., streamed from a video website), the video annotations can be displayed to Bob at the times, locations, and with the content (e.g., name of resort, link to resort, surf class rates, link to travel website) designated by Alice.

### SUMMARY

This document describes techniques, methods, systems, and computer program products for providing dynamic content (e.g., text, hyperlinks, images, animations, videos, sounds, etc.) with an electronic video. Extra-video content (e.g., a video annotation) to be displayed with a video can be dynamically retrieved when (or within a threshold amount of time of) serving a request for a video. For example, expanding upon the example above, Alice can add dynamic video annotations to her Hawaii video that are configured to display the current weather conditions in Hawaii at the time the user requests and/or views the video. When Bob requests Alice's video regarding Hawaii from the video website, the current weather conditions in Hawaii can be retrieved and displayed to Bob as an annotation in the video at a time and location designated by Alice.

Content can be dynamically selected and retrieved for a video according to a template designated by a user and/or entity associated with a video, such as an author of the video (e.g., uploader of the video, creator of the video, copyright holder, etc.). Content can be selected based on a variety of factors, such as information regarding the video requestor (e.g., geographic location of the video requestor, social network presence of the video requestor, etc.). Content can be dynamically retrieved from any of a variety of third-party electronic content providers, such as social networks (e.g., FACEBOOK), travel server systems (e.g., KAYAK.COM), and/or electronic reference sources (e.g., WIKIPEDIA).

Further expanding upon the example above, instead of providing a static link to a travel website as the third video annotation, Alice can create a content template such that the third video annotation includes current airfare deals from a video requestor's current geographic location to Hawaii. For example, assume that Bob is located in New York, N.Y., and that Bob (through a computing device) requests Alice's video regarding Hawaii from a server system hosting Alice's video. Based on the template designated by Alice, the server system can determine Bob's current geographic location (e.g., look-up Bob's geographic location using his internet protocol (IP) address, obtain/receive Bob's geographic locations through cell-tower triangulation or a global positioning system (GPS), etc.) and retrieve information regarding current airfare offers from New York to Hawaii (e.g., interact with a third-party travel site). These airfare offers can then be provided to Bob as content (e.g., video annotation) at a specific time (e.g., the 45 second mark) and in a specific location during playback of the Hawaii video.

In one implementation, a computer-implemented method includes receiving, at a computer server system, a request from a client computing device for an electronic video; and dynamically identifying content to display while the video is played based on one or more content parameters that are associated with the video and indicate, at least, a type of dynamic content to be identified after the request is received, the dynamic content being content of a type that can change automatically over time between playing of the electronic video. The method can further include providing the identified dynamic content to the client computing device in a form so that the dynamic content will be displayed on the client computing device in accordance with one or more display parameters that indicate, at least, a time during playback of the video or a location in relation to the video at which the dynamic content is displayed. As part of the computer-implemented method, the content parameters and the display parameters are designated by a first user associated with the video before the request is received.

In another implementation, a computer-implemented method includes receiving, at a computer server system, a request from a client computing device for an electronic video. The method can also include generating code to provide to the client computing device that, when interpreted by the client computing device, will cause the client computing device to dynamically identify content to display while the video is played, wherein the code is generated to include one or more content parameters that are associated with the video and indicate, at least, a type of dynamic content to be identified, the dynamic content being content of a type that can change automatically over time between playing of the electronic video. The method can further include providing the generated code and one or more display parameters to the client computing device, wherein the one or more display parameters indicate, at least, a time during playback of the video or a location in relation to the video at which the dynamic content to be identified by the client computing device is displayed. As part of the method, the content parameters and the display parameters are designated by a first user associated with the video before the request is received.

In another implementation, a system for providing dynamic content with an electronic video includes one or more computer servers and an interface for the one or more servers that is configured to receive a request from a client computing device for an electronic video. The system can further include a dynamic content identification component of the one or more servers that is configured to dynamically identify content to display while the video is played based on one or more content parameters that are associated with the video and indicate, at least, a type of dynamic content to be identified after the request is received, the dynamic content being content of a type that can change automatically over time between playing of the electronic video. The system can additionally include a dynamic content subsystem of the one or more servers that is configured to provide the identified dynamic content to the client computing device in a form so that the dynamic content will be displayed on the client computing device in accordance with one or more display parameters that indicate, at least, a time during playback of the video or a location in relation to the video at which the dynamic content is displayed. As part of the system, the content parameters and the display parameters are designated by a first user associated with the video before the request is received.

The details of one or more embodiments are set forth in the accompanying drawings and the description below. Various advantages can be provided by the techniques, methods, systems, and computer program products described herein. For example, providing dynamic content with videos can make videos more relevant to a given user. For instance, content that links a user to a video (e.g., airfare offers from the user's current location to a destination depicted in the video) can be dynamically selected based on information about the user, such as the user's current geographic location.

In another example, providing dynamic content can make videos more relevant to the present time. For instance, news regarding the subject of a video can be dynamically identified and provided as content with the video. Such news can fill-in an information gap that may exist between when the video was created and when a user is requesting the video.

In a further example, providing dynamic content can reduce the amount of time an author of a video would otherwise spend to keep the video updated. With static video annotations, an author monitors for current information and then, once updates are identified, manually edits annotations to include the updated information. In contrast, a user can create a template once and the template can subsequently be referenced to identify and retrieve dynamic content over the life of the video without further action by the user.

Additionally, dynamic content can be localized for a user. Localization can include presenting the dynamic content to a user in the user's preferred language (e.g., Spanish, Arabic, English, etc.), currency (e.g., Euros, U.S. dollars, etc.), and/or time format (e.g., 12 hour format, 24 hour format). Localization information for a user can be indicated by a user's computing device, such as by the user's web browser or other client application. For example, Arabic-language viewers can be presented with dynamic content for a video annotation as Arabic text and Spanish-language viewers can be presented with dynamic content for the same video annotation as Spanish text.

Other features, objects, and advantages of the invention will be apparent from the description and drawings, and from the claims.

### DESCRIPTION OF DRAWINGS

FIG. 1 is a conceptual diagram of an example system for providing dynamic content with an electronic video.

FIG. 2 depicts an example system for providing dynamic content with an electronic video.

FIGS. 3A-D depict example techniques for providing dynamic content with an electronic video.

FIGS. 4A-F are screenshots of example electronic videos being displayed with dynamically identified content.

FIG. 5 is a block diagram of computing devices that may be used to implement the systems and methods described in this document, as either a client or as a server or plurality of servers.

Like reference symbols in the various drawings indicate like elements.

### DETAILED DESCRIPTION

This document generally describes techniques, methods, systems, and computer program products for providing dynamic content (e.g., text, hyperlink, image, animation, video, sound, etc.) with an electronic video (e.g., streamed electronic video, downloaded electronic video, etc.). Content can be dynamically identified and retrieved for a video in response to a request for the video from a client computing device (e.g., laptop computer, desktop computer, smartphone, mobile phone, tablet computing device, etc.). Dynamically identified content can be provided to and displayed on a client computing device in conjunction with playback of a video (e.g., the dynamic content can be displayed as a video annotation overlaying a portion of the video). Dynamic content can augment or supplement an electronic video.

For example, a user Carl creates an electronic video that shows races in which the ten fastest 100-meter sprinting times were recorded, and he uploads the video to a video server system (e.g., FACEBOOK, YOUTUBE, etc.) for distribution to other users. Knowing that the top ten 100-meter sprinting times are likely to change over time, Carl designates a variety of parameters to be used to dynamically identify and display information regarding current top ten 100-meter times at a future time when his video is viewed by another user. For instance, Carl can designate content parameters and display parameters to be used to identify and display dynamic content (information regarding current top ten 100-meter times) with his video. Content parameters can specify a type of dynamic content to be retrieved (e.g., factual/sports information) and parameters for identifying the desired content (e.g., current top ten 100-meter sprint times). Display parameters can specify a time, duration, and/or location at which the dynamic content is to be displayed in association with the video (e.g., display the current top ten 100-meter times in a column down the right side of the video for the last 30 seconds of playback).

Expanding upon this example further, the video server system can use the parameters designated by Carl to identify and provide dynamic content to future viewers in association with Carl's video. For instance, several years after Carl uploaded/last updated his video, another user Dave requests (through a computing device) Carl's video from the video server system. In response to Dave's request, the video server system can identify the current top ten 100-meter sprint times from a content source (e.g., a third-party content provider like WIKIPEDIA or a search engine that is provided with keywords identified by Carl) using, at least, the content parameters designated by Carl. Additionally, the video server system can configure Carl's video and/or the retrieved dynamic content (current top ten 100-meter sprint times) such that the dynamic content is displayed with Carl's video in accordance with the specified display parameters (e.g., display the current top ten 100-meter times in a column down the right side of the video for the last 30 seconds of playback). The video server system can provide the dynamic content with the requested video to the computing device from which Dave requested Carl's video. During playback of the video on the computing device, Dave can be presented with the information regarding the current top ten 100-meter sprint times without either he or Carl having to seek out such information or update the video/information associated with the video.

As described in greater detail below, a variety of parameters can be used to identify and provide dynamic content. For example, dynamic content can be identified based on information associated with a computing device and/or user requesting a video. For instance, a geographic location associated with the computing device and/or user requesting a video can be used to identify dynamic content to be presented with the video (e.g., identify show times for a movie at a movie theater geographically located near a user). In another example, dynamic content can be identified based on information associated with other users. For instance, comments and/or recommendations posted by acquaintances (e.g., friends, business contacts, family, etc.) of a requesting user in a social network (e.g., FACEBOOK, LINKEDIN, MYSPACE, TWITTER, etc.) can be used to identify dynamic content to provide to the requesting user with a video.

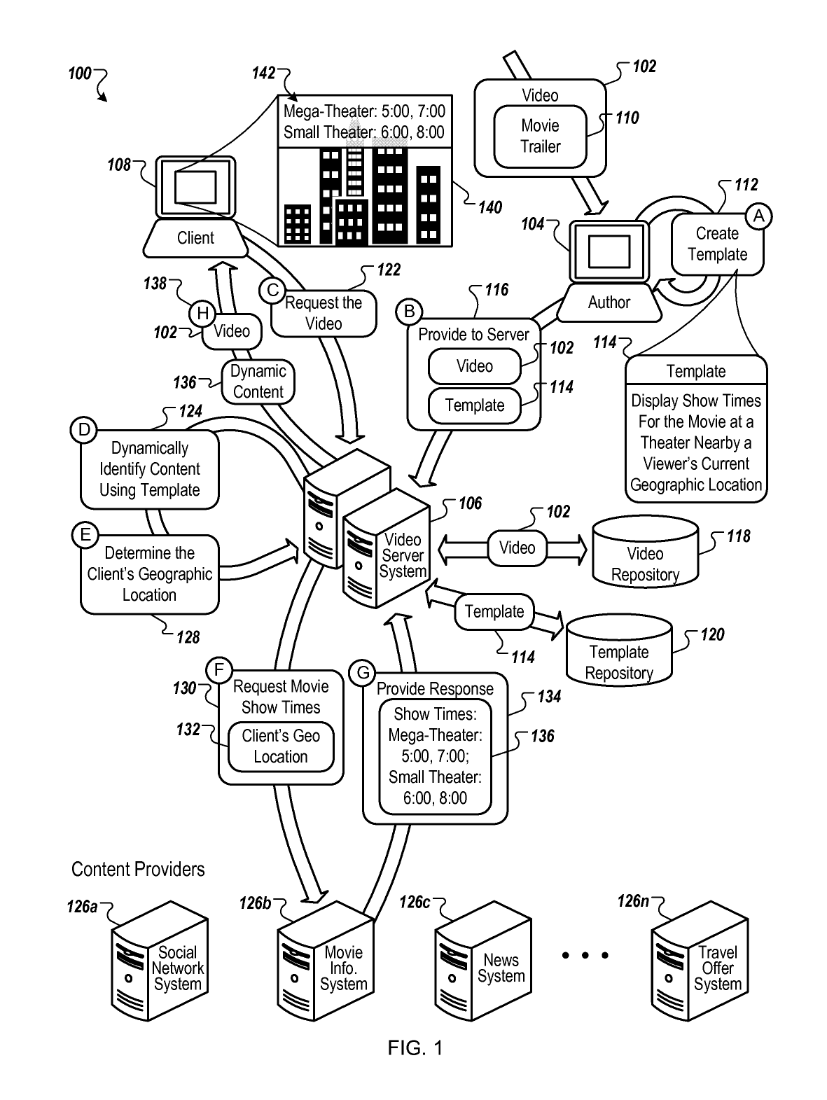

FIG. 1 is a conceptual diagram of an example system 100 for providing dynamic content with an electronic video 102. The example system 100 is depicted as including an author computing device 104 that uploads the video 102 to a video server system 106. The system 100 also depicts a client computing device 108 that subsequently requests the video 102 from the video server system 106 and, in response, is provided with the video 102 and dynamically identified content for the video 102.

The electronic video 102 can be any digitally formatted/encoded video file, such as a FLASH video file (e.g., .flv file, .fl4 file), an MPEG-2 encoded video file, an MPEG-4 encoded video file, a webm formatted video file (e.g., .webm file), a VP8 encoded video file (e.g. .vp8 file), and QUICKTIME formatted video file (e.g., .mov file). In the example system 100, the video 102 is depicted as including a movie trailer 110.

The author computing device 104 can be any of a variety of computing devices, such as a laptop computer, a desktop computer, a smartphone, a mobile phone, a tablet computing device, and a netbook. The author computing device 104 is depicted as receiving the video 102. For example, the video 102 can be received from another computing device (e.g., downloaded from another computing device), read by the author computing device 104 off of a computer readable storage medium (e.g., a flash memory device, a CD/DVD, etc.), and/or created using a video editing application installed on the author computing device 104.

As depicted by step A (112), the author computing device 104 creates a template 114 for the video 102 (and the movie trailer 110). The template 114 can include the parameters (e.g., content parameters, display parameters, etc.) used by the video server system 106 to identify dynamic content to provide with the video 102. In this example system 100, the template 114 includes parameters that specify that the dynamic content for the video 102 should include show times for the movie (previewed in the movie trailer 110) at one or more theaters located near a viewer's current geographic location. For instance, based on the parameters outlined in the template 114, a first user geographically located in New York, N.Y., will be provided with information (e.g., show times, street address, cost, etc.) regarding movie theaters located in New York that are showing the movie depicted in the movie trailer 110, and a second user geographically located in Zurich, Switzerland, will be provided with different information regarding movie theaters located in Zurich that are showing the movie.

Although the template 114 is depicted as including content parameters, other parameters can be included in the template 114. For instance, the template 114 can include display parameters that specify a time during playback of the video 102 at which the dynamic content is provided (e.g., displayed, played, etc.), a duration for which the dynamic content is provided, effects that are applied to the dynamic content as it is provided (e.g., fade-in, fade-out, transparency level, font, color, etc.), and/or a location relative to the video at which the dynamic content is to be provided (e.g., overlay the video, displayed next to the video, etc.).

The template 114 can be created by the author computing device 104 alone or in conjunction with the video server system 106. For example, the author computing device 104 can run a standalone application that is configured to generate the template 114, such as a video editing/annotation application installed on the author computing device 104. In another example, the author computing device 104 can create the template 114 through interactions with the video server system 106, such as through a browser-based application provided to the author computing device 104 by the video server system 106 through a network (e.g., the Internet).

As depicted in step B (116), the author computing device 104 provides the video 102 and the template 114 to the video server system 106. For example, the author computing device 104 can upload the video 102 and the template 114 to the video server 106 for distribution to other users. The template 114 can be uploaded in association with the video 102 so that the video server system 106 references the template 114 to dynamically provide content with the video 102 when serving requests for the video 102.

The video server system 106 can include one or more computer servers, such as a co-located server and a distributed server system. The video server system 106 can be part of a greater computer server system and/or network, such as a group of server systems that together serve requests for a website, such as a social network website. The video server system 106 stores the video 102 and the associated template 114 in a video repository 118 and a template repository 120, respectively. The video repository 118 and the template repository 120 can be any of a variety of storage devices and/or structures, such as a file system/structure, a database, and/or a data server system. The video server system 106 waits for requests for the video 102 after storing the video 102 and the template 114.

As depicted by step C (122), the client computing device 108 (similar to the author computing device 104) provides an electronic request for the video 102 to the video server system 106 through a network (e.g., the Internet, a local area network (LAN), a wide area network (WAN), etc.). For example, the request can be provided to the video server system 106 in response the client computing device 108 requesting a web page that includes the video 102.

In response to receiving the request from the client computing device 108, the video server system 106 dynamically identifies content to be provided with the video 102 using the template 114, as indicated by step D (124). For example, the video server system 106 can identify that the template 114 is associated with the video 102 requested by the client computing device 108 and can evaluate the parameters contained in the template 114 to determine how to obtain the dynamic content. For example, the video server system 106 can determine a type of dynamic information that is being requested (e.g., movie information, travel information, factual/reference information, social network information, etc.) and, based on the type of information, identify one or more content providers to contact to obtain the dynamic content. The example system 100 includes content providers 126a-n, where content provider 126a is a social network system (e.g., FACEBOOK, LINKEDIN, TWITTER, etc.), content provider 126b is a movie information system (e.g., MOVIEFONE, movie theater company, etc.), content provider 126c is a news system (e.g., news aggregator, really simple syndication (RSS) news feed, etc.), and content provider 126n is a travel offer system (e.g., TRAVELOCITY, KAYAK, etc.). A variety of other content providers not depicted can also be part of the system 100.

In the depicted example, the video server system 106 can determine that the type of information requested in the template 114 is movie information. Accordingly, the video server system 106 can identify that movie information system 126b as the content provider to contact to obtain the desired dynamic content for the video 102. The video server system 106 can make such a determination based on a pre-determined association of content types and content providers. Additionally, in some instances the video server system 106 itself can be identified as the content provider for a particular type of content, such as video-related content. The video server system 106 can identify more than one content providers, such as when the template 114 specifies more than one type of information should be provided with the video 102 (e.g., provide show times for the movie 110 and recent reviews of the movie 110 from news organizations).

The video server system 106 can also determine whether the identified content provider 126b will need additional information outside of the template 114 to provide the desired dynamic content for the video. For instance, the template 114 indicates the viewer's geographic location should be taken into account when identifying a movie theater for show times. Based on the template 114, the video server system 106 can determine the geographic location of the client computing device 108 (and/or a user associated with the client computing device 108), as indicated by step E (128). Any of a variety of techniques for determining geographic location information (e.g., country, state/region, postal code, longitude and latitude, etc.) can be employed by the video server system 106, such as cross-referencing an IP address for the client computing device 108 with associated geographic locations. The video server system 106 can identify other information outside of the template 114 to provide to one or more of the content providers 126a-n, such as social network information (e.g., username) for users associated with the author computing device 104 and/or the client computing device 108.

As indicated by step F (130), the video server system 106 provides a request for the dynamic content to the movie information system 126b (the identified content provider for the type of dynamic content specified in the template 114) with geographic location information 132 for the client computing device 108. In response, the movie information system 126b identifies a theater located near the geographic location of the client computing device 108 and provides response to the video server system 106, as indicated by step G (134), with dynamic content 136. In this example, the dynamic content 136 includes information for show times at the Mega-Theater and the Small Theater for the movie depicted in the movie trailer 110. This dynamic content 136 can vary depending on the geographic location for the client computing device 108 (e.g., the client computing device 108 may relocated to a different geographic location) and the time at which the request for the video 102 is provided to the video server system 106.

The video server system 106 provides the video 102 and the dynamic content 136 to the client computing device 102, as indicated by step H (138). The video server system 106 can configure the video 102 and/or information provided with the video (e.g., a web page within which the video 102 is being presented) to reference and display the dynamic content 138 during video playback. The dynamic content 138 can additionally be re-configured and/or re-formatted for presentation with the video 102 (e.g., the dynamic content 138 may be provided by the content server 126b in a format different than a format used for presentation with the video 102). The video 102 and the dynamic content 138 can be provided by the video server system 106 to the client computing device 108 together or separate.

For example, the video server system 106 can serve the video 102 to the client computing device 108 with the video 102 (and/or associated information) initialized to request annotations for the video 102. For instance, an annotations field associated with the video 102 can be set to true and an annotations source can be set to the video server system 106. When a video client (e.g., FLASH player, QUICKTIME player, etc.) on the client computing device 108 begins to load the video 102 for playback, the video client can request the annotations from the video server system 106, which can then perform steps D-H to provide the dynamic content 136 to the client computing device 102. In another example, the video 102 and the dynamic content 136 can be provided to the client computing device 108 concurrently, which the video 102 being initialized to locate and/or reference the dynamic content 136 locally on the client computing device 108.

The client computing device 108 can play the video 102 received from the video server system 106, as depicted by the example video image 140. Additionally, the dynamic content 136 is presented in the box 142 (e.g., an annotation) overlaying the top portion of the video image 140. The box 142 can be located in the top portion of the video image 140 and can be presented at a specific time during playback of the video 102 according to the template 114. In the example depicted, the box 142 containing the dynamic content 136 is semi-transparent so that it does not fully obscure any portion of the video 102. Other effects can be used to integrate the dynamic content 136 into playback of the video 102.

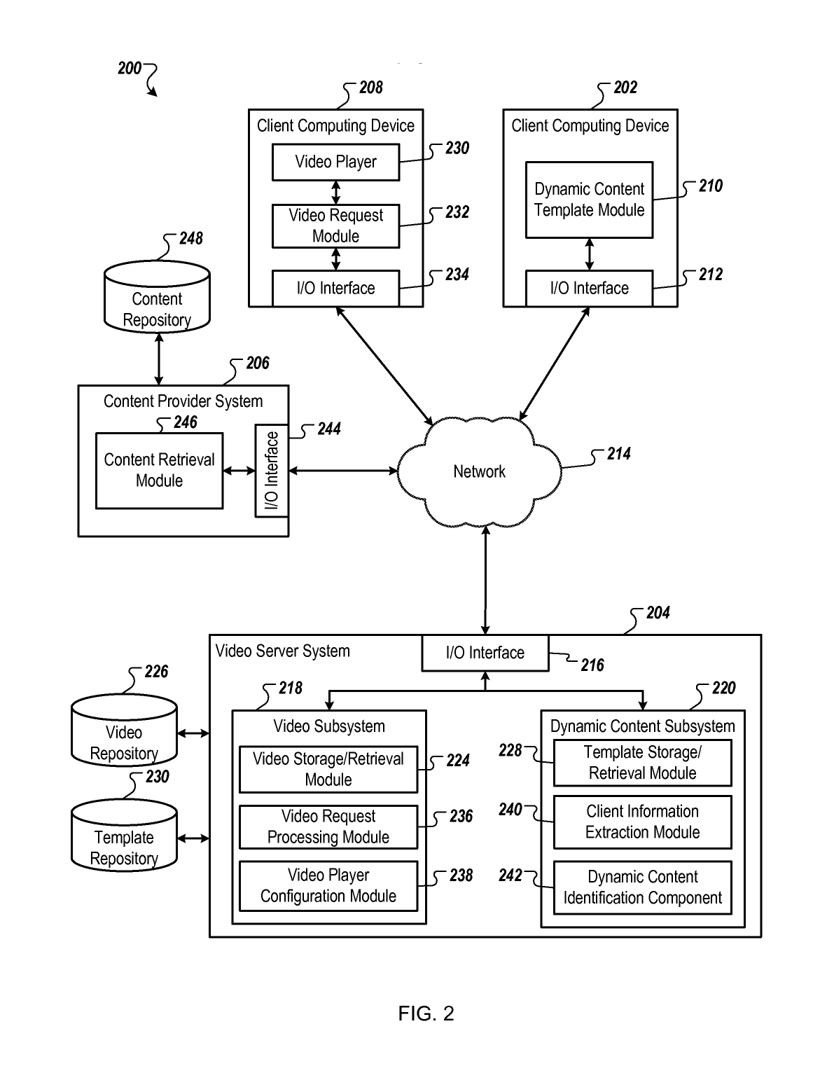

FIG. 2 depicts an example system 200 for providing dynamic content with an electronic video. The system 200 is similar to the system 100 described above with regard to FIG. 1. The system 200 includes a client computing device 202 that is configured to provide dynamic content templates to a video server system 204. The video server system 204 is configured to serve videos to a client computing device 206 with content dynamically identified from a content provider system 208.

The client computing device 202 is similar to the author computing device 104 described above with regard to FIG. 1. The client computing device 202 can be any of a variety of computing devices, such as a laptop computer, a desktop computer, a smartphone, and a tablet computing device. The client computing device includes a dynamic content template module 210 that is configured to provide an interface (e.g., a graphical user interface (GUI)) through which a user of can create a dynamic content template for a video. The dynamic content template module 210 can generate a dynamic content template based on user input received through the interface provided by the dynamic content template module 210. Dynamic content templates can include various parameters for dynamic content to be identified for an electronic video, similar to the template 114 described above with regard to FIG. 1.

The client computing device 202 can provide created templates to the video server system 204 using an input/output (I/O) interface 212 that is configured to communicate with the video server system 204 over a network 214. The I/O interface 212 can be any type of interface configured to send and receive information over the network 214, such as an Ethernet card, a wireless network transmitter, and a cellular signal transmitter. The network 214 can be any of a variety of communications networks, such as the Internet, a LAN, a WAN, a 3G/4G wireless network, a fiber-optic network, or any combination thereof.

The client computing device 202 can additionally provide an electronic video with which a generated dynamic content template is associated to the video server system 204 over the network 214. The dynamic content template module 210 and/or the video server system 204 can use any of a variety of authentication procedures to check whether a user submitting a dynamic content template for a video is authorized to do so. Various associations between users and videos can provide sufficient authorization, such as a user having uploaded the video to which the dynamic content template pertains, the user being the creator of the video, and/or the user being the copyright holder of the video.

The video server system 204 can receive videos and dynamic content templates through an I/O interface 216 that is similar to the I/O interface 212 of the client computing device 202. The video server system 204 includes a video subsystem 218 and a dynamic content subsystem 220. The video subsystem 218 is configured to manage storage and serving of electronic videos to client computing devices. The dynamic content subsystem 220 is configured to identify and provide dynamic content in conjunction with videos being served to client computing devices.

The video subsystem 218 includes a video storage/retrieval module 224 that is configured to store and retrieve videos. The video storage/retrieval module 224 can interact with a video repository 226 to store and retrieve videos. The video repository 226 is similar to the video repository 118 described above with regard to FIG. 1. The video storage/retrieval module 224 can store videos provided by the client computing device 202 in the video repository 226 and, in response to a request for a video from the client computing device 208, can retrieve stored videos from the video repository 226.

The dynamic content subsystem 220 includes a template storage/retrieval module 228 that is configured to store and retrieve dynamic content templates. The template storage/retrieval module 228 can interact with a template repository to store and retrieve templates. The template repository 230 is similar to the template repository 120 described above with regard to FIG. 1. The template storage/retrieval module 228 can store templates provided by the client computing device 202 in the template repository 230 and, in response to a request for a video from the client computing device 208, can retrieve stored templates from the template repository 230 to identify dynamic content for the requested video.

The client computing device 208 is similar to the client computing device 202 and the client computing device 108 described above with regard to FIG. 1. The client computing device 208 is depicted as including a video player 230 (e.g., FLASH player, QUICKTIME player, etc.) that is configured to play electronic videos and a video request module 232 (e.g., a web browser application, etc.) that is configured to request electronic videos from the video server system 204. The video request module 232 can transmit an electronic request for a video to the server system 204 over the network 214 through an I/O interface 234, which is similar to the I/O interfaces 212 and 216.

The video server system 204 can receive such video requests from the client computing device 208 through the I/O interface 216. In response to receiving a video request, the video storage/retrieval module 224 retrieves the requested video from the video repository 226. The video subsystem 218 can further include a video request processing module 236 that is configured to process a video request. Processing a video request can include retrieving and assembling other information to provide with the video request, such as retrieving code and images for a web page of which the requested video is a part.

The video subsystem 218 can also include a video player configuration module 238 that generates information to be provided with a requested video that initiates the video player 230 to provide dynamic content with the video. For example, the video player configuration module 238 can set a flag associated with a requested video indicating to the video player 230 that extra-video content should be displayed with the video. The video player configuration module 230 can also set a resource identifier to indicate a location at which the dynamic content can be retrieved to provide with the video.

In some implementations, the video request processing module 236 can also instruct the dynamic content subsystem 220 to identify dynamic content to be provided with the video, and can assemble the dynamic content with the video (and other information) to provide to the client computing device 208. In such implementations, the video player configuration module 238 can set the resource identifier to indicate that the dynamic content has been provided with the video to the client computing device 208.

In other implementations, the video request processing module 236 does not interact with the dynamic content subsystem 220 and the requested video is provided to the client computing device 208 initially without the dynamic content. In such implementations, the video player configuration module 238 can set the resource identifier for the dynamic extra-video content to a resource location associated with the video server system 204 and, more specifically, the dynamic content subsystem 220. Such a setting can cause the video player 230 of the client computing device 208 to request the dynamic content form the video server system 204 after at least a portion of the requested video has been provided to the client computing device 208.

In response to receiving a request for dynamic extra-video content (from the video subsystem 218 and/or the client computing device 208), the dynamic content subsystem 220 can retrieve one or more templates associated with the relevant video using the template storage/retrieval module 228 and the template repository 230. The dynamic content subsystem 220 also includes a client information extraction module 240 that can determine whether any client-related information in needed to identify the dynamic content. The client-related information can pertain to the client computing device 202 (and/or a user associated with the client computing device 202) that provided the video and/or dynamic content template, to the client computing device 208 (and/or a user associated with the client computing device 208) that is requesting the video, and/or to other users/client computing devices. For example, the client information extraction module 240 can determine a geographic location associated with the client computing device 208.

The dynamic content subsystem 220 additionally include a dynamic content identification component 242 that is configured to identify dynamic content to provide to the client computing device 208 in conjunction with a requested video. The dynamic content identification component 242 can identify dynamic content based on the parameters set forth in a dynamic content template associated with the requested video. Based on the template, the dynamic content identification component 242 can obtain the desired dynamic content based on interaction with the content provider system 206, which can be identified as the appropriate content provider from among multiple content providers.

The dynamic content identification component 242 can request dynamic content from the content provider system 206 over the network 214 using parameters contained in a dynamic content template and client/user information identified by the client information extraction module 240. The content provider system 206 includes an I/O interface 244, similar to he I/O interfaces 212, 216, and 234. The content provider system 206 includes a content retrieval module 246 that is configured to serve requests for content. The content retrieval module 246 can obtain the requested information from a content repository 248 that is configured to store various content that is maintained by the content provider system 206. The content provider system 206 provides the requested content back to the dynamic content subsystem 220, which can in turn provide the content to the video subsystem 218 and/or to the client computing device 208.

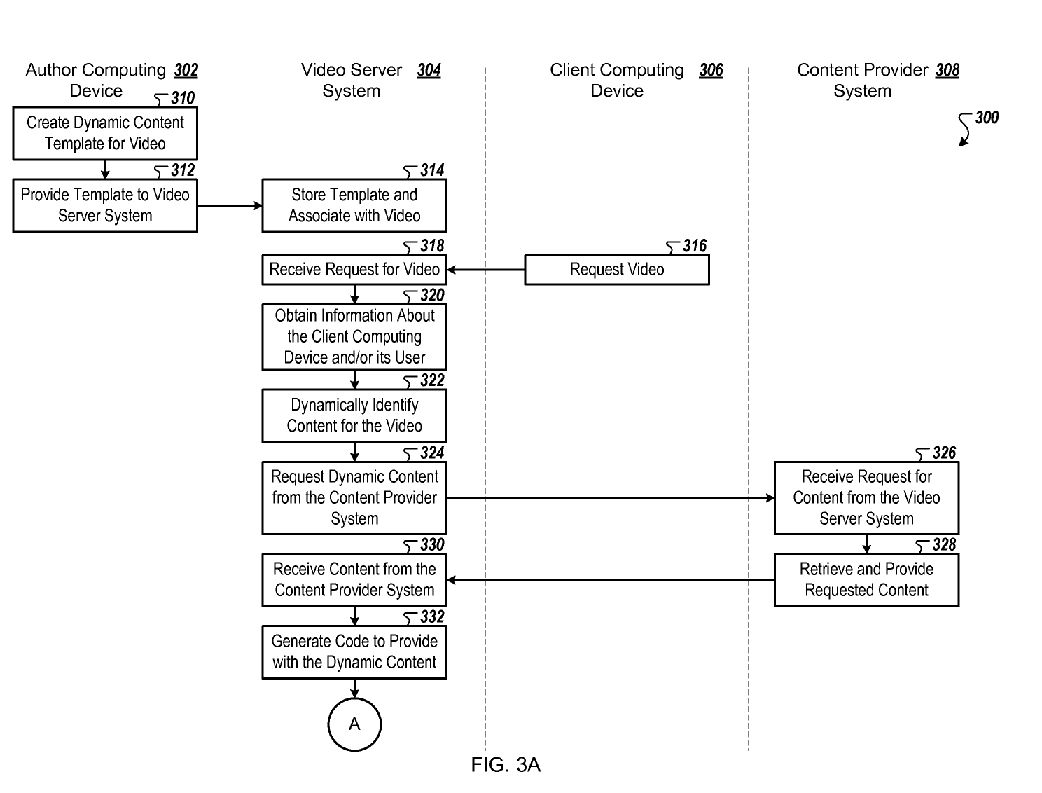

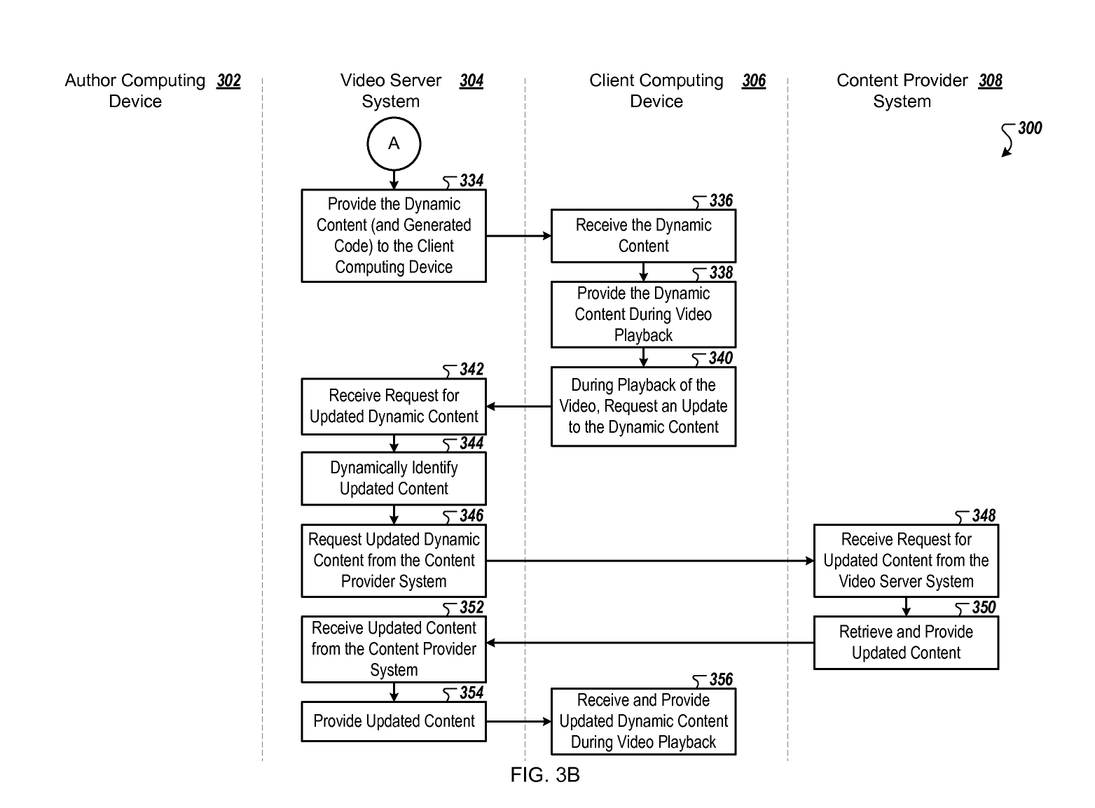

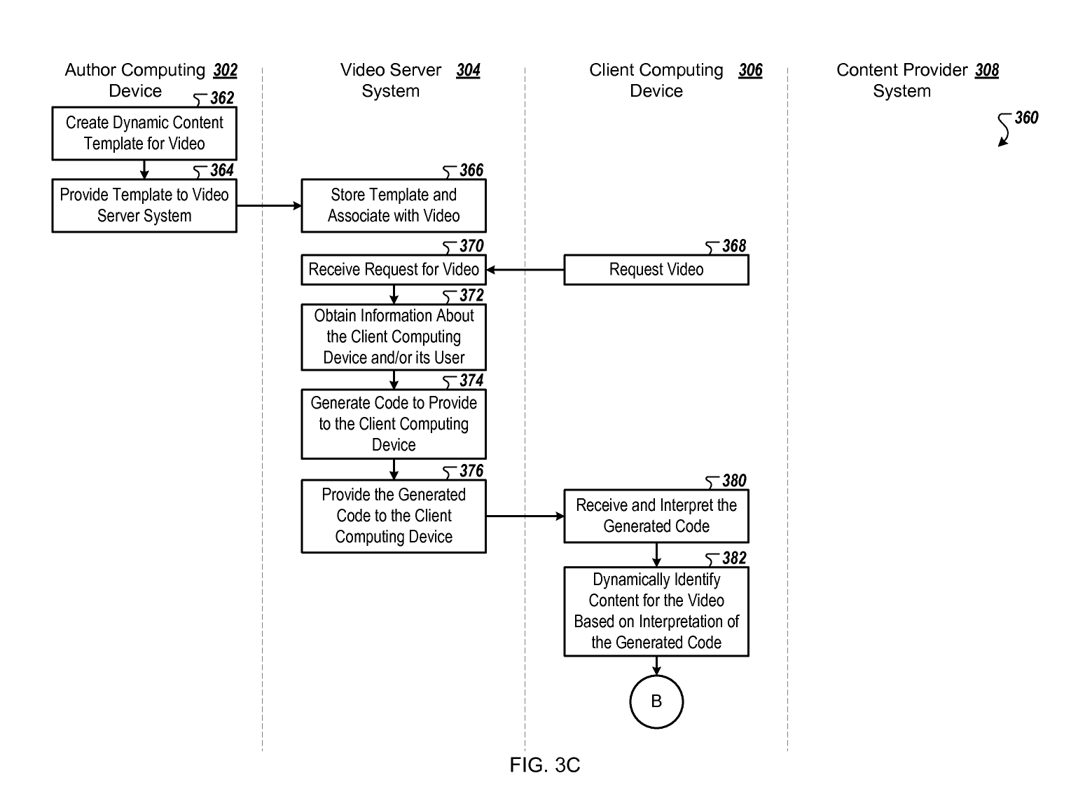

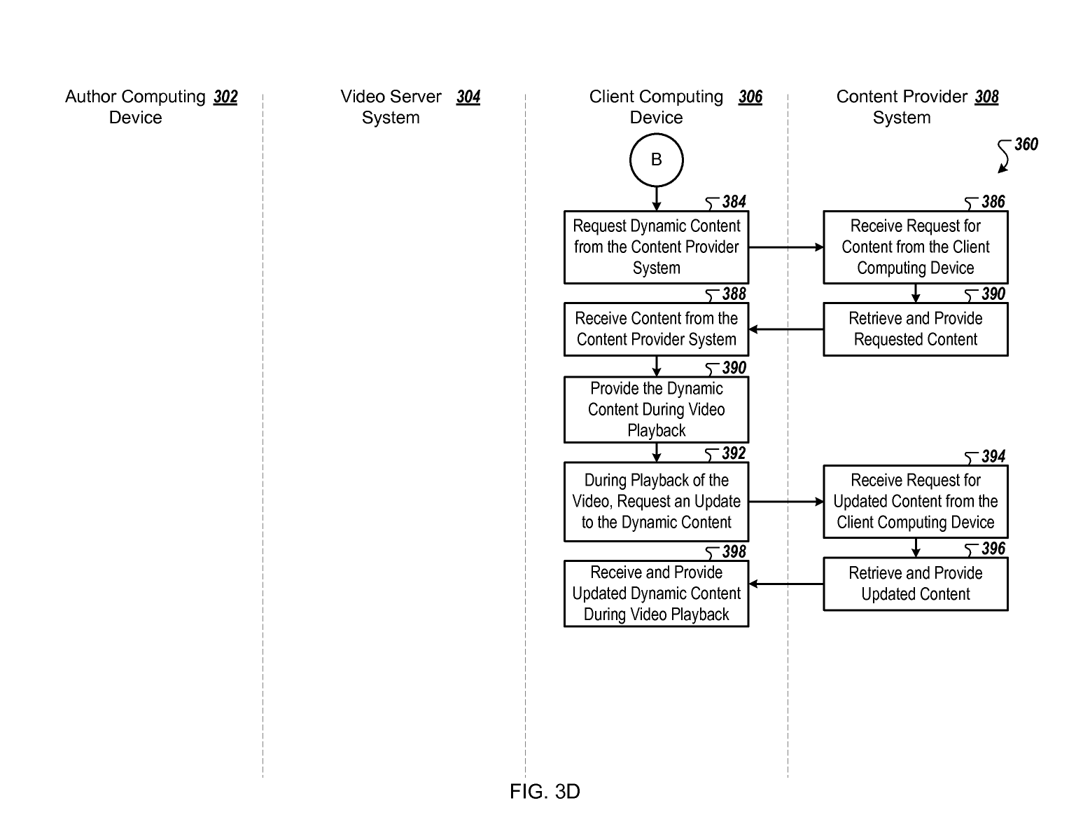

FIGS. 3A-D depict example techniques 300 and 360 for providing dynamic content with an electronic video. The techniques 300 and 360 are similar to the techniques for providing dynamic content with an electronic video described above with regard to FIGS. 1 and 2. Portions of the techniques 300 and 360 are depicted as being performed by an author computing device 302, a video server system 304, a client computing device 306, and a content provider system 308. The author computing device 302 is similar to the author computing device 104 and/or the client computing device 202 described above with regard to FIGS. 1 and 2, respectively. The video server system 304 is similar to the video server system 106 and/or the video server system 204 described above with regard to FIGS. 1 and 2, respectively. The client computing device 306 is similar to the client computing device 108 and/or the client computing device 208 described above with regard to FIGS. 1 and 2, respectively. The content provider system 308 is similar to the content provider systems 126a-n and/or the content provider system 206 described above with regard to FIGS. 1 and 2, respectively.

Referring to FIG. 3A, the technique 300 begins at step 310 by the author computing device 302 creating a dynamic content template for an electronic video. At step 312, the author computing device 302 provides the created template to the video server system 304. The created template can include content parameters and/or display parameters for the dynamic content. The content parameters can indicate a variety of parameters to use for selecting the dynamic content, such as indicating a type of dynamic content to be identified. The display parameters can indicate a variety of information associated with display of the dynamic content with the video, such as information indicating a time during which and/or a location at which the dynamic content should be displayed during playback of the video.

The video server system 304 receives and stores the created template as being associated with the video so that the template can be readily identified when serving the video (step 314). Although not depicted, the author computing device 302 can also provide the video server system 304 with the electronic video with which the created template is associated, which can be stored by the video server system 304 in preparation for distribution to other users and/or computing devices.

At step 316 the client computing device 306 provides a request for the electronic video to the video server system 304. The video server system 304 receives the request from client computing device 306 (step 318) and proceeds to obtain information about the client computing device 306 and/or a user associated with the client computing device 306 (step 320). The information can be provided by the client computing device 306 to the video server system 304 and/or retrieved/determined by the video server system 304. For example, the client computing device 306 can provide information regarding its current geographic location to the video server system 304. In another example, the video server system 304 can determine such information for the client computing device 306 based on other information associated with the client computing device 306, such as an IP address for the client computing device 306.

Using the parameters contained in the template for the video (e.g., content parameters) and/or the obtained information regarding the client computing device 306 and/or its user, the video server system 304 can dynamically identify content to be provided with the video (step 322).

For example, the video server system 304 can obtain information in step 320 that identifies a geographic location associated with the client computing device 306 and/or the user of the client computing device 306. Such obtained geographic location information can be used to identify a variety of dynamic content. For instance, this obtained geographic location information can be used to identify dynamic content (in step 322) that includes a show time for a movie, a concert, or a performance (that is a subject of the video with which the dynamic content is being provided) at a venue (e.g., theater, stadium, club, bar, etc.) located within a threshold distance of the geographic location (e.g., within a few city blocks, one mile, one kilometer, etc.).

In another example, the obtained geographic location information can be used to identify dynamic content (in step 322) that includes a schedule for a travel carrier route (e.g., scheduled airline route, scheduled train route, scheduled bus route, etc.) to or from a port (e.g., airport, train station, seaport, etc.) within a threshold distance of the geographic location (e.g., within a few city blocks, one mile, one kilometer, etc.). The port that is within the threshold distance of the current geographic location for the client computing device (and/or its associated user) can be at least one of the geographic locations serviced by the travel carrier route. Another one of the geographic locations serviced by the travel carrier route can be include another geographic location that is a subject of at least a portion of the video.

In a further example, the video server system 304 can obtain information in step 320 that is associated with a social network profile for a user of the client computer device 306. Such obtained social network information can be used to identify a variety of dynamic content. For instance, such social network information can be used to identify dynamic content (in step 322) that includes comments and/or status information for one or more acquaintances of the user on one or more social networks. The identified social network information can be identified as pertaining to at least one subject that is presented in the video. For instance, social network information having a tag (e.g., a hash tag) and/or keyword that is similar to information that identifies subjects presented in the video (e.g., tags/text associated with the video, analysis of the content of the video, etc.) can be identified as pertaining to the video.

The video server system 304 can retrieve such dynamic content from the content provider system 308 by providing a request for the dynamic content to the content provider system 308 (step 324). The request for the dynamic content can be provided to the content provider system 308 in response to the request for the video received at step 318. The request for dynamic content can also (or alternatively) be provided before the request is received as part of a pre-caching operation whereby the dynamic content is cached and periodically updated (e.g., updated every minute, hour, day, week, month, etc.) in anticipation of receiving the request from the client computing device 306. By pre-caching the dynamic content, the video server system 304 may be able to more quickly serve the dynamic content in response to a request from the client computing device 306.

The content provider system 308 receives the request for the dynamic content (step 326), retrieves the requested content, and provides the requested content to the video server system 304 (step 328). The video server system 304 receives the content from the content provider system (step 330). The video server system 304 can generate code to provide with the dynamic content (step 332). For instance, the video server system 304 can provide code to initialize a video player on the client computing device 306 to request and/or display the dynamic content with the video. In another example, the video server system 304 can generate code that will cause the client computing device 308 to request updated dynamic content from the video server system 304 and/or from the content provider system 308 after a threshold amount of time has elapsed since receiving the dynamic content and/or playing the video. For instance, such code can cause the client computing device 306 to request updated dynamic content every few minutes (e.g., 2 minutes, 5 minutes, 10 minutes, 30 minutes, etc.) during playback of the video.

Referring to FIG. 3B, the video server system 304 can provide the dynamic content and the generated code to the client computing device 306 (step 334). The dynamic content can be provided with the associated video or can be provided in response to a request from the client computing device 306 for the dynamic content (e.g., the client computing device 306 can be provided with the video and code indicating that dynamic content for the video can be retrieved from the video server system 304). The client computing device 306 receives the dynamic content (step 336) and provides the dynamic content at a time and location during playback of the video, as specified by the parameters of the dynamic content template (step 338).

During playback of the video, the client computing device 306 can request an update to the received dynamic content from the video server system 304 (step 340). The client computing device 306 can be cause to provide such a request based on the code generated by the video server system 304 in step 332. The video server system 304 receives the request for updated dynamic content (step 342) and identifies updated dynamic content in response (step 344). Step 344 can be similar to the step 322 described above, just performed at a later time to retrieve more current/up-to-date content. Similar to steps 324-330, the video server system 304 requests updated dynamic content from the content provider system 308 (step 346), the content provider system 308 receives the request (step 348) and retrieves and provides the updated content (step 350), which is received by the video server system 304 (step 352). The updated dynamic content can then be provided to the client computing device 306 by the video server system 304 (step 354) and displayed in conjunction with the video on the client computing device 306 (step 356).

Although not depicted in FIGS. 3A-B, the client computing device 306 may receive dynamic content from the content provider system 308 instead of from the video server system 304. For instance, the video server system 304 may provide the client computing device 306 with information identifying the appropriate content provider system 308 and with information indicating various content parameters to provide to the content provider system 308 in order to obtain the desired dynamic information.

The content provider system 308 can be any of a variety of content sources. For example, the content provider system 308 can provide one or more electronic syndication feeds (e.g., RSS feed, blog service, news service, etc.). For example, such an electronic feed can syndicate micro-blogs (e.g., blogs with character limits for each blog entry) for users of a social network (e.g., TWITTER, FACEBOOK, etc.). Dynamic content may be identified from an electronic syndication feed based on a variety of information indicating a type of content provided in the electronic feed, such as tags (e.g., hash tags) and keywords.

In another example, the content provider system 308 can provide one or electronic reference sources, such as electronic encyclopedias (e.g., WIKIPEDIA, etc.), electronic dictionaries (e.g., DICTIONARY.COM, etc.), electronic thesauruses (e.g., THESAURUS.COM, etc.), electronic search engines (e.g., BING, YAHOO! SEARCH, etc.), or any combination thereof. Dynamic content can be identified from these reference sources based variety of information indicating content topics, such as tags and keywords.

In another example, the content provider system 308 can provide TV broadcast schedules, such as TV show times and durations. Such TV broadcast schedules can be identified as dynamic content for a client computing device based on a variety of information regarding the client computing device (and/or a user of the client computing device), such as the current geographic location, time zone, and/or preferred language. Such information can be provided by the client computing device (e.g., client provides geographic location information, preferred language, etc.) and/or can be inferred/determined (e.g., look-up IP address for the client computing device and infer associated information like language preference).

FIGS. 3C-D depict the example technique 360. The technique is like the technique 300 described above, but in the technique 360 the client computing device 306 retrieves dynamic content from the content provider system 308 instead of receiving the dynamic content from the video server system 304. In the technique 360, the video server system 304 generates code that, when interpreted by the client computing device 306, causes the client computing device 306 to identify and retrieve dynamic content from the content provider system 308.

Referring to FIG. 3C, the technique 360 begins by the author computing device 302 creating a dynamic content template for an electronic video (step 362) and providing the created template to the video server system 304 (step 364), similar to steps 310 and 312 described above with regard to technique 300. The video server system 304 receives and stores the created template as being associated with the video so that the template can be readily identified when serving the video (step 314), similar to step 314 described above with regard to the technique 300.

Similar to steps 316-320, the client computing device 306 provides a request for the electronic video to the video server system 304 (step 368), the video server system 304 receives the request from client computing device 306 (step 370), and the video server system 304 obtains information about the client computing device 306 and/or a user associated with the client computing device 306 (step 372).

At step 374, the video server system 304 generates code to provide to the client computing device 306. The code is generated such that, when the code is interpreted by the client computing device 306, it will cause the client computing device 306 to dynamically identify and retrieve content to provide with the video. The code is generated based on the obtained information about the client computing device 306 (and/or the user of the client computing device 306) and/or the dynamic content template for the video, as designated by the author computing device 302. The code can include a variety of information to assist the client computing device 306 in identifying and retrieving the dynamic content, such as a set of instructions to be executed and/or information that identifies the content provider system 308.

At step 376, the video server system 304 provides the generated code to the client computing device 306. The client computing device 306 receives and interprets the generated code (step 380). Based on interpretation of the generated code, the client computing device 306 dynamically identifies content to provide with the video (step 382), similar to the dynamic identification discussed above with regard to step 322.

Referring to FIG. 3D, the client computing device 306 requests the dynamic content from the content provider system 308 (step 384). Similar to steps 326-328, the content provider system 308 receives the request for content from the client computing device (step 386), and retrieves and provides the requested content to the client computing device 306 (step 390). The client computing device receives the content from the content provider system (step 388) and, similar to step 338, provides the dynamic content during playback of the video (step 390). In some implementations, the client computing device 306 can obtain dynamic content to provide with the video locally and without having to interact with the content provider system 308. For instance, the dynamic content can derived from be files and/or data that are stored on the client computing device 306.

The generated code provided to the client computing device 306 by the video server system 304 can additionally cause the client computing device 306 to request updated dynamic content after a threshold amount of time has elapsed (e.g., threshold amount of time has elapsed since the dynamic content was received, threshold amount of time has elapsed during playback of the video, etc.). At step 392, the client computing device 306 can request an update to the dynamic content during playback of the video. Similar to steps 348-350, the content provider system 308 receives the request for updated content (step 394), and retrieves and provides the updated content to the client computing device 306 (step 396). Similar to step 356, the client computing device 306 receives the updated dynamic content and provides the updated content during playback of the video (step 398).

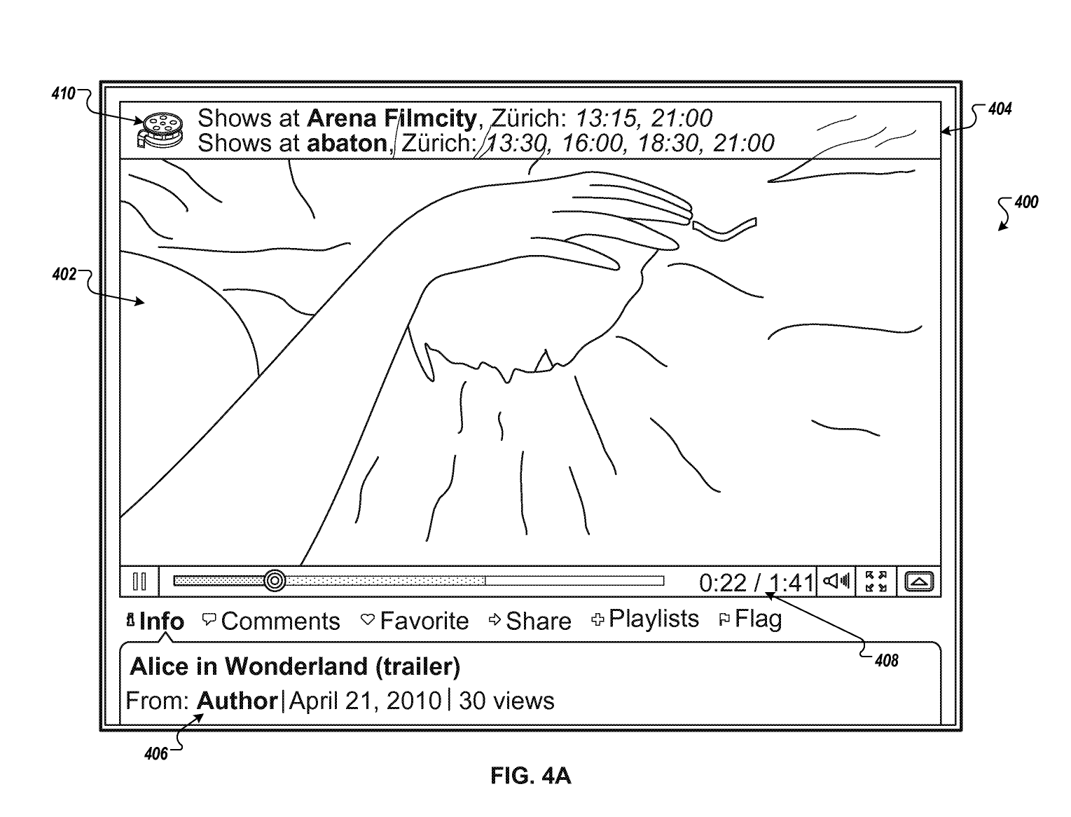

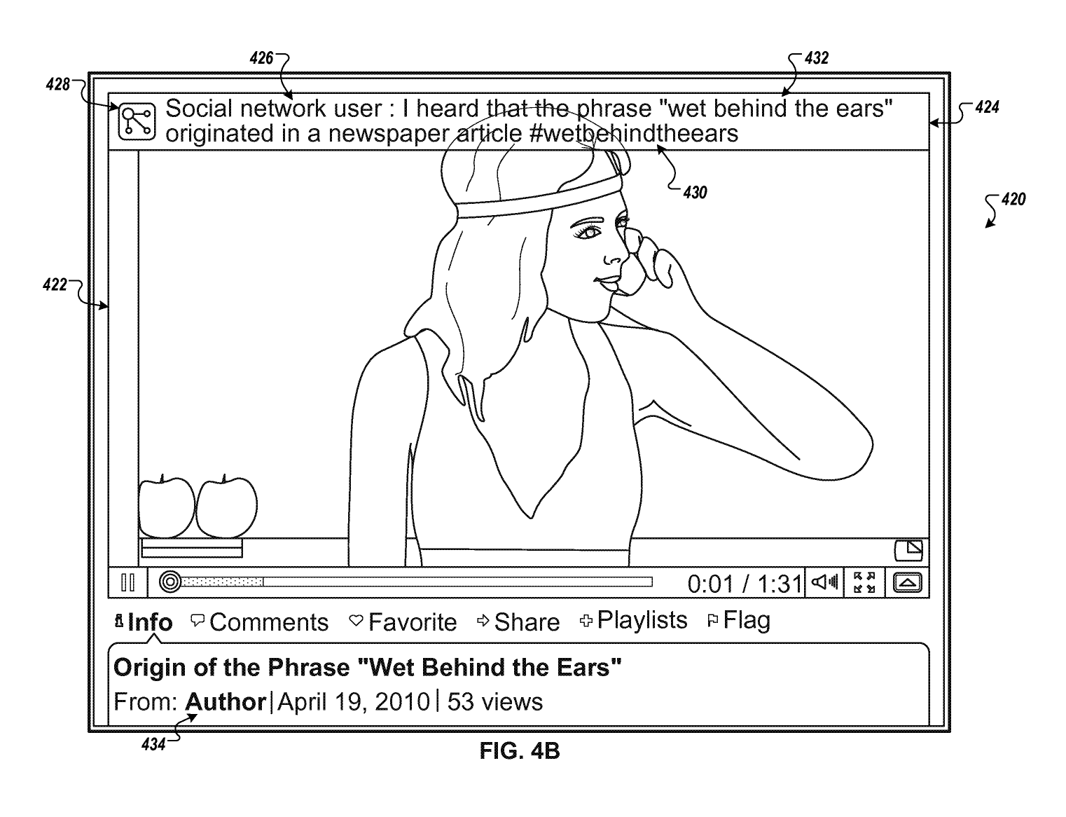

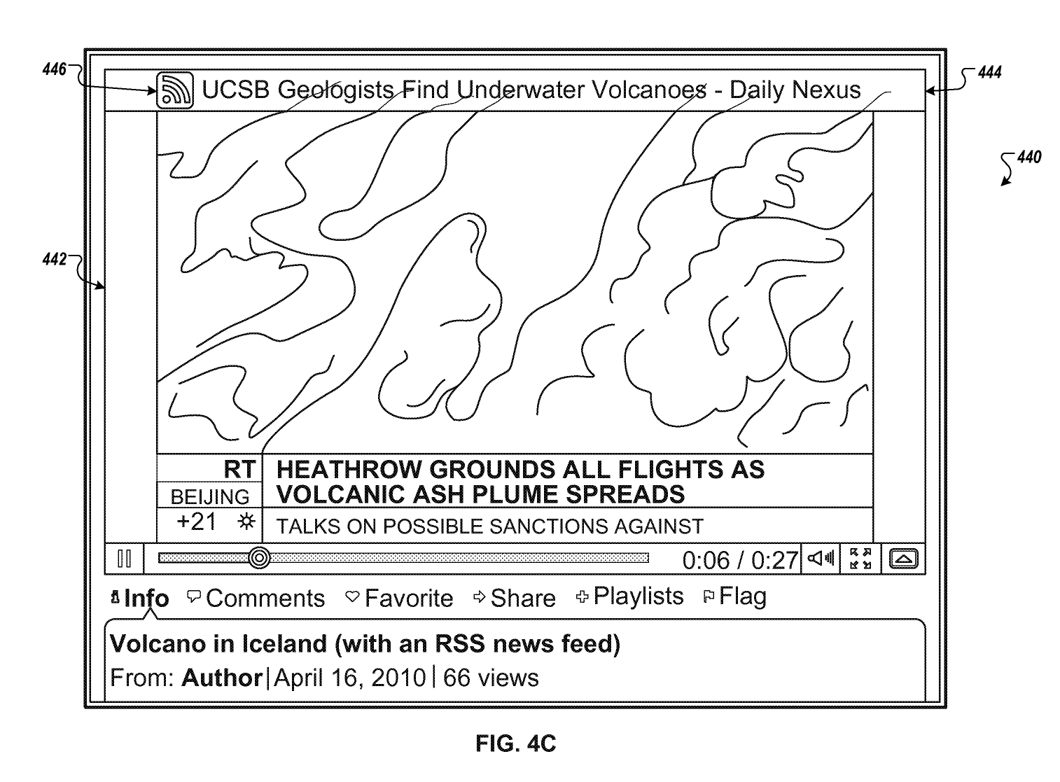

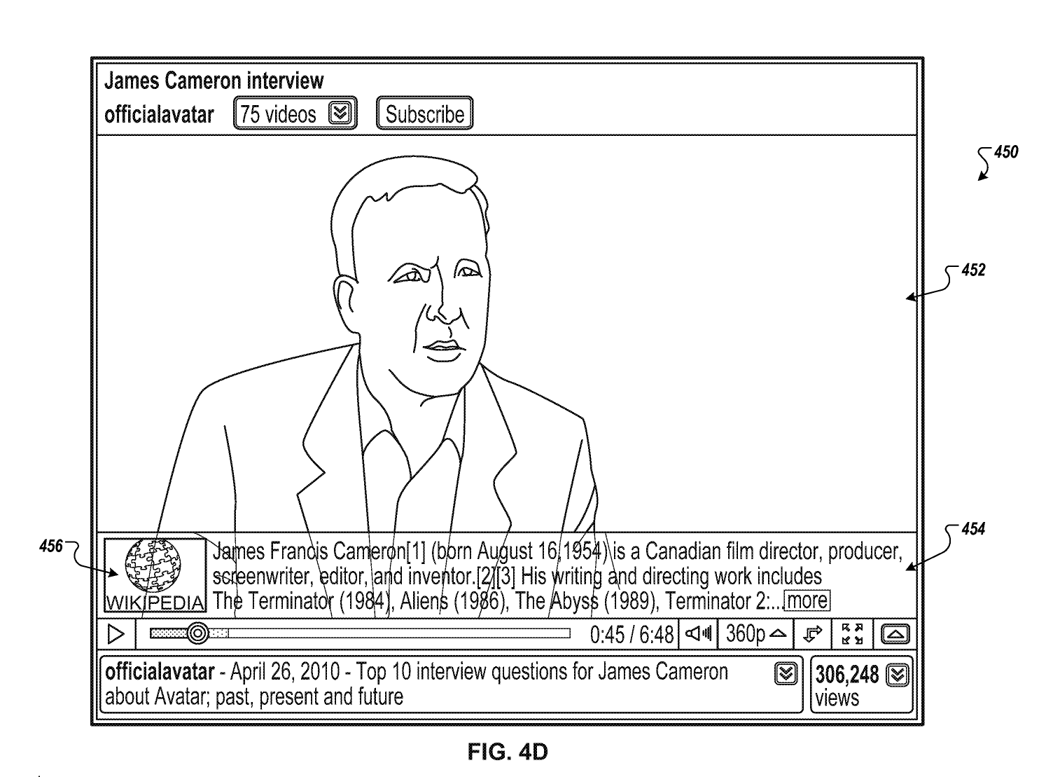

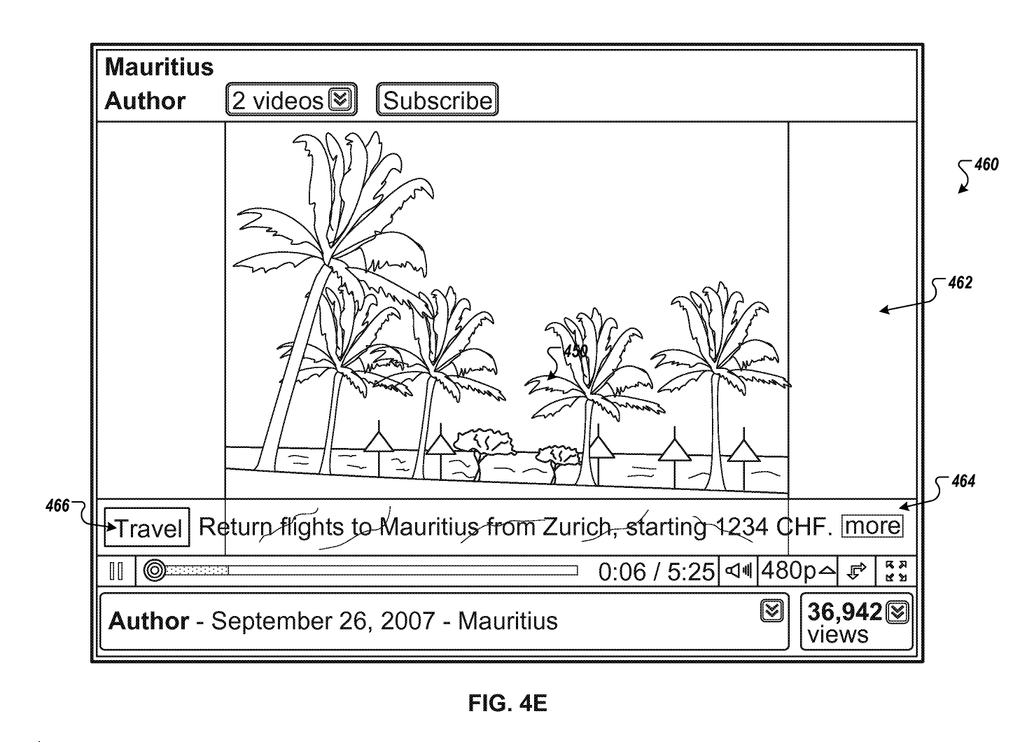

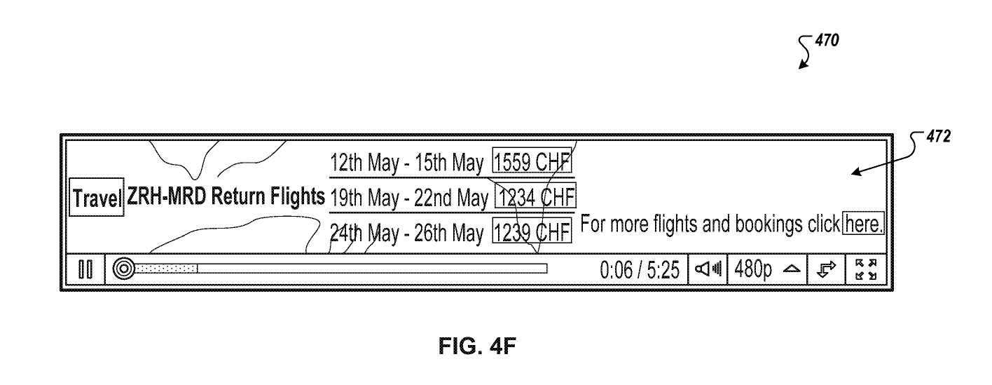

FIGS. 4A-F are screenshots of example electronic videos being displayed with dynamically identified content. The screenshots depict various examples of dynamic content that can be identified and provided to a client computing device for display during playback of an electronic video. The screenshots are from the perspective of a client computing device, such as the client computing devices 108, 208, and 306 described above.

FIG. 4A shows a screenshot 400 of a video 402 for a trailer of the movie Alice in Wonderland being played on a client computing device located in Zurich, Switzerland. Dynamic content 404 is overlaid the top portion of the video 402 as it is being played. In this screenshot, the dynamic content 404 includes upcoming show times for Alice in Wonderland at two movie theaters in Zurich that are located nearby the user/client computing device that is viewing the video 402.

In this example, the author 406 of the video 402 may have designated that dynamic content for the video 402 should include show times for the movie Alice in Wonderland at theaters geographically located near the viewer (user and/or client computing device viewing the video 402). The author 406 may have also designated that the dynamic content 404 is to overlay the top portion of the video 402 from the 0:22 mark (as indicated by the time counter 408) of the video 402 until the end of the video.

The dynamic content 404 is also depicted as providing an icon 410 that indicates a source of the dynamic content. In this example, the source is a movie information system, such as the movie information system 126b described with regard to FIG. 1.

FIG. 4B shows a screenshot 420 of a video 422 regarding the origin of the phrase “wet behind the ears” that is being played on a client computing device. Dynamic content 424 is displayed overlaying the top portion of the video 422. In this example, the dynamic content 424 includes information generated by a user 426 of a social network (as indicated by the icon 428 for the social network) regarding the phrase “wet behind the ears”. The dynamic content 424 can be identified for presentation with the video 422 based on information indicating that the content pertains to the video 422, such as the hash tag 430 (#wetbehindtheears) and/or the keywords “wet behind the ears” 432 included in the content. The dynamic content 424 may have generated by the user 426 after the video 422 and/or an associated dynamic content template were uploaded for distribution to other users.

The dynamic content 424 may be identified for presentation based on the user 426 being an acquaintance on a social network (e.g., friend, business associate, etc.) of a user requesting/viewing the video 422. The author 434 of the video 422 may designate whether or not the information retrieved from the social network 428 should be from an acquaintance of the viewer.

FIG. 4C shows a screenshot 440 of a video 442 of a news report regarding flights a Heathrow Airport grounding flights because of a volcanic ash plume. Dynamic content 444 is overlaid the top portion of the video 442. The dynamic content 444 includes related news regarding volcanoes from an RSS feed (as indicated by the RSS icon 446).

FIG. 4D shows a screenshot 450 of a video 452 of an interview with movie director James Cameron. Dynamic content 454 is displayed overlaying the bottom portion of the video 452. The dynamic content 454 includes background information for James Cameron from an electronic encyclopedia (as indicated by the icon 456).

FIG. 4E shows a screenshot 460 of a video 462 regarding the island of Mauritius. Dynamic content 464 is displayed overlaying the bottom portion of the video 462. The dynamic content 464 includes information regarding offers from a travel offer system (as indicated by the icon 466) for airfare between the viewer's current location in Zurich, Switzerland to Mauritius.

FIG. 4F shows a screenshot 470 of other example dynamic content 472 from the travel over system that can be displayed with the video 462. The dynamic content 472 presents a variety of travel dates and prices for airfare between Zurich and Mauritius.

Although dynamic content is depicted in the FIGS. 4A-F as being presented on the top or bottom of a video, other locations are possible. For instance, a column of information can be presented anywhere on or adjacent to a video.

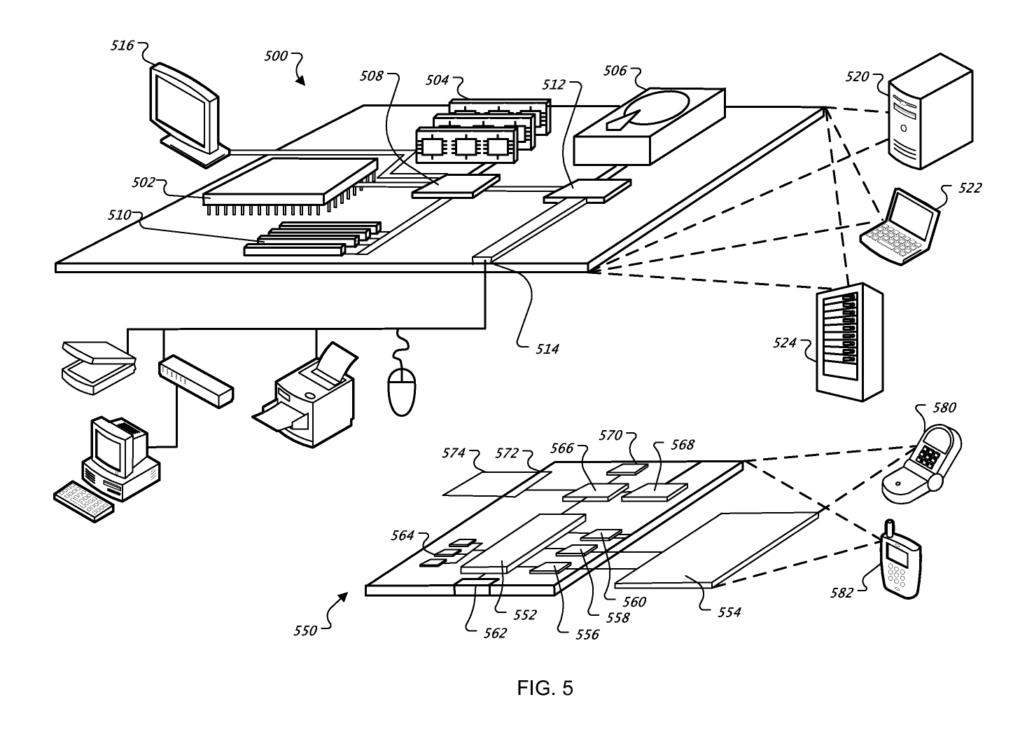

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for providing dynamic content with an electronic video may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method comprising:
receiving, at a computer server system, a request from a client computing device for an electronic video;
dynamically identifying content to display while the video is played based on one or more content parameters that are associated with the video and indicate, at least, a type of dynamic content to be identified after the request is received, the dynamic content being content of a type that can change automatically over time between playing of the electronic video; and
providing the identified dynamic content to the client computing device in a form so that the dynamic content will be displayed on the client computing device in accordance with one or more display parameters that indicate, at least, a time during playback of the video or a location in relation to the video at which the dynamic content is displayed;
wherein the content parameters and the display parameters are designated by a first user associated with the video before the request is received.

2. The computer-implemented method of claim 1, further comprising obtaining information regarding the client computing device or a second user associated with the client computing device;
wherein the dynamic content is identified additionally based on the obtained information.

3. The computer-implemented method of claim 2, wherein the obtained information identifies a geographic location that is associated with the client computing device or the second user; and
wherein, based on the obtained information, the dynamic content is associated with the geographic location.

4. The computer-implemented method of claim 3, wherein the dynamic content comprises information that indicates a show time for a movie, a concert, or a performance at a venue located within a threshold distance of the geographic location.

5. The computer-implemented method of claim 4, wherein at least a portion of the video pertains to the movie, the concert, or the performance.

6. The computer-implemented method of claim 3, wherein the dynamic content comprises information that indicates a schedule for a travel carrier route to or from a port within a threshold distance of the geographic location.

7. The computer-implemented method of claim 6, wherein at least a portion of the video pertains to another geographic location that is serviced by the travel carrier route.

8. The computer-implemented method of claim 2, wherein the obtained information is associated with a social network profile for the second user on a social network.

9. The computer-implemented method of claim 8, wherein the dynamic content comprises comments or status information for one or more acquaintances of the second user on the social network.

10. The computer-implemented method of claim 9, wherein the comments and the status information pertain to at least one subject that is presented in the video.

11. The computer-implemented method of claim 1, further comprising retrieving, by the computer server system, the dynamic content from one or more third-party computer server systems.

12. The computer-implemented method of claim 11, wherein the dynamic content is retrieved after and in response to the request is received.

13. The computer-implemented method of claim 11, wherein the dynamic content is retrieved as part of a pre-caching operation before the request is received and is periodically updated by the computer server system.

14. The computer-implemented method of claim 1, further comprising:
during playback of the video on the client computing device, receiving a second request from the client computing device for an update to the dynamic content;
in response to the received second request, dynamically identifying updated content to display to while the video is played based on the content parameters; and
providing the updated dynamic content to the client computing device in a form so that the updated dynamic content will be displayed on the client computing device in accordance with the display parameters.

15. The computer-implemented method of claim 14, further comprising generating code to provide to the client computing device with the dynamic content that, when executed by the client computing device, causes the client computing device to provide the second request to the computer server system for the updated dynamic content after a threshold amount of time has elapsed.

16. The computer-implemented method of claim 1, wherein the content parameters and the display parameters are part of a template that defines dynamic annotations to be presented while the video is played.

17. The computer-implemented method of claim 1, wherein the dynamic content is configured to overlay at least a portion of the video during playback; and
wherein the display parameters define, at least, a location and a time at which the dynamic content is displayed with the video.

18. The computer-implemented method of claim 1, wherein the dynamic content is identified from one or more electronic syndication feeds based on one or more content tags specified by the content parameters.

19. The computer-implemented method of claim 18, wherein the electronic syndication feeds comprise micro-blogs associated with a plurality of distinct users.

20. The computer-implemented method of claim 1, wherein the dynamic content is identified from one or electronic reference sources based on one or more content topics specified by the content parameters.

21. The computer-implemented method of claim 20, wherein the electronic reference sources comprise electronic encyclopedias, electronic dictionaries, electronic thesauruses, electronic search engines, or a combination thereof.

22. A computer-implemented method comprising:
receiving, at a computer server system, a request from a client computing device for an electronic video;
generating code to provide to the client computing device that, when interpreted by the client computing device, will cause the client computing device to dynamically identify content to display while the video is played, wherein the code is generated to include one or more content parameters that are associated with the video and indicate, at least, a type of dynamic content to be identified, the dynamic content being content of a type that can change automatically over time between playing of the electronic video;
providing the generated code and one or more display parameters to the client computing device, wherein the one or more display parameters indicate, at least, a time during playback of the video or a location in relation to the video at which the dynamic content to be identified by the client computing device is displayed;
wherein the content parameters and the display parameters are designated by a first user associated with the video before the request is received.

23. The computer-implemented method of claim 22, wherein the generated code includes information that identifies one or more third-party computer server systems for the client computing device to contact to obtain the dynamic content.

24. The computer-implemented method of claim 22, wherein the generated code further causes the client computing device to obtain updated dynamic content after a threshold amount of time has elapsed.

25. A system for providing dynamic content with an electronic video, the system comprising:
one or more computer servers;
an interface for the one or more servers that is configured to receive a request from a client computing device for an electronic video;
a dynamic content identification component of the one or more servers that is configured to dynamically identify content to display while the video is played based on one or more content parameters that are associated with the video and indicate, at least, a type of dynamic content to be identified after the request is received, the dynamic content being content of a type that can change automatically over time between playing of the electronic video; and
a dynamic content subsystem of the one or more servers that is configured to provide the identified dynamic content to the client computing device in a form so that the dynamic content will be displayed on the client computing device in accordance with one or more display parameters that indicate, at least, a time during playback of the video or a location in relation to the video at which the dynamic content is displayed;
wherein the content parameters and the display parameters are designated by a first user associated with the video before the request is received.
